(19) United States
(12) Patent Application Publication
(10) Pub. No.: US 2024/0212658 A1
(43) Pub. Date: Jun. 27, 2024

(54) EFFECTS PEDAL BOARD BONDING SYSTEM

(71) Applicant: Jando LLC, Austin, TX (US)

(72) Inventor: Olaf Reistrup, Austin, TX (US)

(21) Appl. No.: 18/145,926

(22) Filed: Dec. 23, 2022

(51) Int. Cl. G10H 1/34

(52) U.S. Cl. CPC G10H 1/348; G10H 2220/265

(57) ABSTRACT

An pedal board bonding system includes a first effect pedal and a pedal board configured to mount the first effect pedal. A first pedal attachment layer is attached to first effect pedal and a pedal board attachment layer is attached to the pedal board base such that the pedal board attachment layer is configured to bond to the first pedal attachment layer.

### BACKGROUND OF THE INVENTION

### 1. Field

The present invention relates generally to a system comprised of a pedal board and one or more effect pedals that are cohesively or otherwise bonded to the power board and coupled to power and signal paths for musicians and audio performance artists.

### 2. Description of Related Art

Effect pedals or “stompboxes” are used by musicians and other audio performance artists to selectively introduce audio effects, such as overdrive, reverb, delay and distortion to the audio signal produced by musical instruments, such as keyboards, electric guitars and electric basses. Effect pedals can also be used to modify vocal signals or to recorded music or other sounds. These effect pedals are commonly placed on a pedal board and coupled in a particular signal chain (or effect chain) sequence through audio patch cables with standard ¼ inch 2-conductor phone plugs between each effect pedal for processing the analog audio signal. Such pedal boards are usually placed on the floor and each effect pedal actuated by the artist's foot to selectively introduce specific audio effects. A musician may desire to change the configuration of the effect pedals to physically move the effect pedal to a different physical location on the pedal board, or to change the order of the signal processing performed by the effect pedals.

Musicians are able to craft a unique sound, timbre or tone by using one or more effect pedals. Music effect pedals modify the input of an analog audio signal by introducing waveform shaping electrical changes to the input signal. The resulting signal can be pitch-shifted, delayed, and equalized to bring out certain frequencies, or modulated to create a chorus, flange or phasing tone. Effects can also be time-based to produce echo, delay and reverb. Populare effect pedals include distortion, overdrive, wah-wah, fuzz, delay, flanger, phaser, reverb, chorus, compression, looping and boost. The order in which these pedals are placed in the signal chain also affects the sound. Compression, overdrive and wah-wah pedals are typically at the start of the signal chain, modulation pedals such as phaser, flanger and chorus in the middle of the signal chain, and time-based pedals such as delay, echo, and revereb the end of the signal chain. Additional pedals to reduce or suppress noise or hum may be placed at the beginning and/or end of the signal chain.

### SUMMARY OF THE INVENTION

The following is a non-exhaustive listing of some aspects of the present techniques for coupling one or more effects pedals to a pedal board. These and other aspects are described in the following disclosure.

It is apparent that a need exists for easily and efficiently attaching, removing, and rearranging effect pedals on a pedal board. The embodiments disclosed herein provide musicians and artists a flexible way to configure and reconfigure pedal boards without wasting excessive time and energy on securing the effect pedals on the pedal board.

Some aspects include a pedal board bonding system that includes a first effect pedal; a pedal board configured to mount the first effect pedal; a first pedal attachment layer attached to the first effect pedal; and a pedal board attachment layer attached to the pedal board base, where the pedal board attachment layer is configured to cohere to the first pedal attachment layer.

Some aspects include a method for configuring the arrangement of effect pedals that are received by the pedal board that includes receiving, at a pedal board, a first effect pedal at a first location on the pedal board bonding the first effect pedal to the first location on the pedal board by placing a first effect pedal attachment layer between a first bottom surface of the first effect pedal and a top surface of the pedal board at the first location; removing, from the pedal board base, the first effect pedal; receiving, at the pedal board base, the first effect pedal at a second location on the pedal board base; and bonding the first effect pedal to the second location on the pedal board by placing the first effect pedal attachment layer between the first bottom surface of the first effect pedal and the top surface of the pedal board at the second location.

These and other advantages of the invention disclosed herein will be apparent to those of ordinary skill in the art by reference to the following detailed description and the accompanying drawings.

### BRIEF DESCRIPTION OF THE DRAWINGS

The above-mentioned aspects and other aspects of the present techniques will be understood when the present application is read in view of the following figures in which like numbers indicate similar or identical elements:

FIG. 1 is a perspective view of a pedal board bonding system depicting multiple effect pedals placed on a pedal board, in accordance with some embodiments of the present disclosure.

FIG. 2A is side view of an effect pedal of FIG. 1, in accordance with some embodiments of the present disclosure.

FIG. 2B is a cross-section view of the effect pedal of FIG. 2A, in accordance with some embodiments of the present disclosure.

FIG. 3 is a cross-section view of the pedal board of FIG. 1, in accordance with some embodiments of the present disclosure.

FIG. 4 is a method of operation of the pedal board system of FIG. 1, in accordance with some embodiments of the present disclosure.

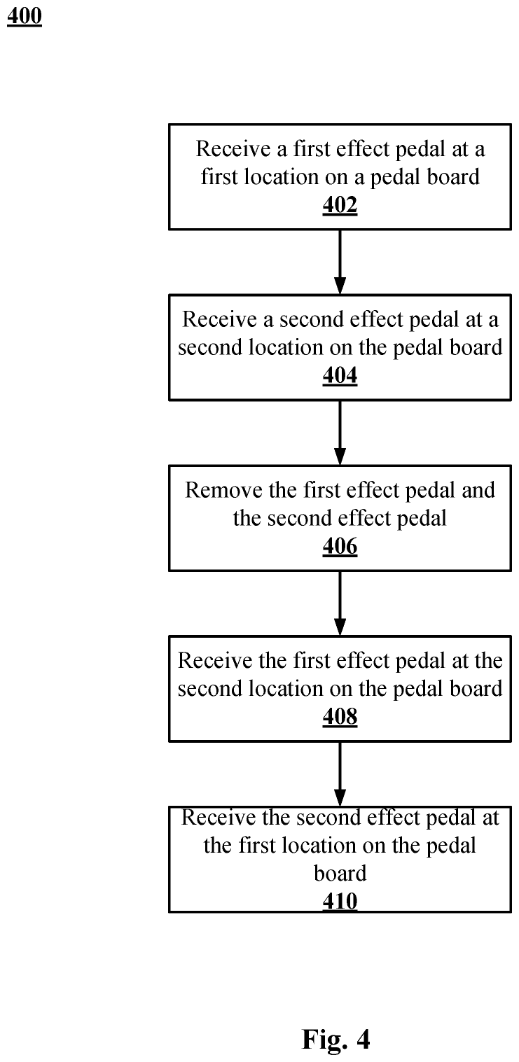

While the invention is susceptible to various modifications and alternative forms, specific embodiments thereof are shown by way of example in the drawings and will herein be described in detail. The drawings may not be to scale. It should be understood, however, that the drawings and detailed description thereto are not intended to limit the invention to the particular form and disclosed, but to the contrary, the intention is to cover all modifications, equivalents, and alternatives falling with the spirit and scope of the present invention as defined by the appended claims.

### DETAILED DESCRIPTION OF CERTAIN EMBODIMENTS

To mitigate the problems described herein, the inventor had to both invent solutions and, in some cases just as importantly, recognize problems overlooked (or not yet foreseen) by others in the field of music production effects pedals, and pedal boards. Indeed, the inventor wishes to emphasize the difficulty of recognizing those problems that are nascent and will become much more apparent in the future should trends in the industry continue as the inventor expects.

Further, because multiple problems are addressed, it should be understood that some embodiments are problem-specific, and not all embodiments address every problem with traditional systems described herein or provide every benefit described herein. That said, improvements that solve various permutations are described below.

Presently, reconfiguring a pedal board entails moving an effect pedal to a different location on the pedal board and reconfiguring the means for attaching the effect pedal to the pedal board. Existing methods for attaching the pedals to the pedal board, such as zip ties or screws, make removal or changing the placement of pedals difficult. Other methods, such as rails with adjustable side clamps or system that require mounting plates for the effect pedals, are expensive and discourage experimentation with pedal placements.

Systems and methods of the present disclosure solve a long-standing challenge of creating a quick and efficient way for removing, rearranging, and reattaching effect pedals onto a pedal board.

In various embodiments of the present disclosure, each effect pedal is attached or bonded to the effect pedal board by an adhesive or cohesive material. In various embodiments, the materials are attached to the effect pedal, the pedal board, or both. The material that allows the effect pedals to cohere to the pedal board may include, for example, polyvinyl chloride (“vinyl”), chlorinated polyvinyl chloride, or other similar cohesive material that would be apparent to one of skill in the art in possession of the present disclosure.

In some embodiments, the ability to easily detach the effect pedals from the pedal board aids the benefits of the wireless powering and outputting of signals of the effect pedals, such as is presented in U.S. Publication 2021/0295809. Rearranging the order of the effect pedals affects the sound of the signal coming out of the effect pedal chain. Being able to move the effect pedals easily and efficiently is therefore beneficial to the signal altering process that the effect pedals perform. By simply switching the order of two effect pedals on the pedal board, the output signal can be drastically different due to the order in which the signal travels through the effect pedals. While wirelessly coupling power and output signals creates an easier system for experimenting and altering the output signal from the chain of the effect pedals, a need for quickly, easily, and efficiently detaching and reattaching the effect pedals is needed. The use of vinyl sheets on the base of the effect pedal and the top surface of the pedal board makes the process of altering the audio signal easier. The vinyl sheets are durable and strong enough to keep the effect pedals attached to the pedal board even when the pedal board is at an angle to the surface upon which it rests. Whenever the effect pedals require rearrangement, the effect pedals are easily removed and reattached to the pedal board.

In an embodiment, a thin layer of vinyl may be attached to the pedal board. The thin layer of vinyl may range from 4 mm to 8 mm thick. The vinyl sheet may cling to the pedal board without the use of an adhesive material between the vinyl and the pedal board. For the vinyl to cling to the pedal board, the sheet attaches to the pedal board material by removing the air in between the vinyl sheet and the pedal board and creating molecular bonding that attaches the vinyl sheet to the pedal board. In an embodiment, a vacuum-like state is created when a pressure difference occurs. The pressure difference forms by attaching a first portion of the vinyl sheet to the pedal board. The atmospheric pressure around the vinyl sheet causes a lower pressure system (in between the vinyl and the pedal board surface) to move outward away from the surface where the vinyl sheet makes contact with the pedal board. This process creates a suction-like effect between the vinyl sheet and the pedal board surface. In another embodiment, a molecular bond is created between the vinyl sheet and the pedal board. As the vinyl sheet comes into contact with the pedal board, the vinyl sheet bonds to the pedal board. The creation of these bonds forces air molecules that were present between the vinyl sheet and the pedal board to be expunged outward away from the interface of the bonded vinyl sheet and pedal board. In order for the vinyl to cling to the pedal board, the pedal board needs to be a smooth, non-porous material that is rigid. Example materials may include aluminum, molded polyethylene, glass, polyvinyl chloride, polished wood, or other plastics.

In an embodiment, a thin layer of vinyl is attached to the effect pedal. The thin layer of vinyl may range from 4 mm to 8 mm thick. The vinyl sheet may cling to the effect pedal without the use of an adhesive material between the vinyl and the effect pedal. For the vinyl to cling to the effect pedal, the sheet attaches to the effect pedal by removing the air in between the vinyl sheet and the effect pedal and creating molecular bonding that attaches the vinyl sheet to the effect pedal. In order for the vinyl to cling to the pedal board, the effect pedal needs to be a smooth, non-porous and nearly flat surface.

If there are components of the effect pedal, such as protruding screws or indentations, that make the bottom surface of the effect pedal non smooth, then a padding material may be placed in between the bottom of the effect pedal and the vinyl sheet. The padding material may be smooth and relatively flat on the side that attaches to the vinyl sheet and may have a thickness of 1 mm to 5 mm. The padding material that attaches to the bottom of the effect pedal may be shaped such that the side of the padding material onto which the vinyl sheet attaches is relatively flat and smooth. Examples of padding materials include foam, wood, slots into which an effect pedal slides, such as aluminum, wood, or polyethylene. In some embodiments, the padding material is attached to the bottom of the effect pedal by an adhesive (e.g., dissipative, mechanical, electrostatic, chemical, etc.). In another embodiment, the padding material is attached to the bottom of the effect pedal by mechanical interlocking.

In some embodiments, the effect pedal is attached to pedal board by placing the effect pedal onto the pedal board. The vinyl sheet attached to the bottom of the effect pedal may cling to the vinyl sheet attached to the top of the pedal board. When the two vinyl sheets make contact, they cling to one another by removing the air in between the two sheets and creating molecular bonding along the surfaces of the vinyl materials. An adhesive (e.g., dissipative, mechanical, electrostatic, chemical, etc.) is not required in order for the two vinyl sheets to cling to one another (e.g., a Van der Waals force at the surface that the two sheets touch binds the sheets together without the need of an adhesive). Instead, cohesive forces between the two vinyl sheets causes the sheets to cling. The tensile strength in the machine direction can range from 2 psi to 20 psi. The tensile strength in the transverse direction can range from 2 psi to 20 psi. Since the tensile strength for the machine and transverse directions are the about same, the vinyl sheets are biaxially oriented. This property proves beneficial when considering the placement of the effect pedals on the pedal boards. Further, the vinyl sheets have a medium surface energy in the range of 30 dynes/cm to 300 dynes/cm. The surface energy of the vinyl sheets and the cohesive force created by placing them together give the vinyl sheets the property of being able to cohere to one another. Similarly, in order for the vinyl sheets to adequately attach to the effect pedals and the pedal boards, the surface energies of the surface of the effect pedal or the surface of the pedal board to which the vinyl attaches may also be at least of medium surface energy (e.g., 30 dynes/cm to 300 dynes/cm). For example, if the surfaces are porous, then the surface energy will be low (less than 30 dynes/cm) and the vinyl will have difficulty staying attached to the surfaces of the effect pedals and the pedal board.

In some embodiments, a vinyl sheet attached to the effect pedal may cover the entirety of the effect pedal's (or padding material's) bottom surface such that the area of the vinyl sheet attached to the effect pedal is about the same as the area of the bottom surface of the effect pedal (or padding material). In another embodiment, the vinyl sheet attached to the bottom of the effect pedal may have an area that is less than the area of the bottom surface of the effect pedal (or padding material). For example, the area of the vinyl sheet me be as small as 50% of the area of the bottom surface of the effect pedal (or padding material). In another embodiment, multiple vinyl sheets may be attached to the bottom surface of the effect pedal (or padding material). The multiple vinyl sheets may be attached to the bottom surface of the effect pedal (or padding material) such that the entire area of the bottom surface (or padding material) may be covered in vinyl sheets, or the multiple vinyl sheets may cover as little as 50% of the bottom surface of the effect pedal (or padding material).

In some embodiments, a vinyl sheet attached to the effect pedal may cover the entirety of the pedal board's top surface such that the area of the vinyl sheet attached to the pedal board is about the same as the area of the top surface of the pedal board. In another embodiment, the vinyl sheet attached to the top of the pedal board may have an area that is less than the area of the top surface. For example, the area of the vinyl sheet me be as small as 50% of the area of top surface of the pedal board. In another embodiment, multiple vinyl sheets may be attached to the top surface of the pedal board. The multiple vinyl sheets may be attached to the top surface of the pedal board such that the entire area of the top surface may be covered in vinyl sheets, or the multiple vinyl sheets may cover as little as 50% of the top surface of the pedal board.

In some embodiments, the vinyl sheets may be affected by temperature. The surface energy of the vinyl sheets will fluctuate as temperature is increased. Therefore, there is a preferred range in which the vinyl sheets can be used. The application of a vinyl sheet requires that the temperature be at least 40° F. Once the vinyl sheets are applied, the temperatures for which the vinyl sheets will stay cohered to one another and the surfaces of the effect pedal and the pedal board ranges from −10° F. to 150° F.

In some embodiments, a vinyl sheet can be heated up, such as by using a heat gun, in order for the it to bond to the surface of an effect pedal or the pedal board. By applying heat to the vinyl sheet, the sheet has a temporary increase in surface energy which helps the sheet bond to the surface.

In some embodiments, the vinyl sheet may be stretched while maintaining its bonding properties. Some vinyl sheets may be stretched up to 200% in either the machine direction or the transverse direction. In a various embodiments, the vinyl sheet may not be stretched past 30% of its original size in order for the vinyl sheet to maintain its bonding properties with respect to the surfaces of the effect pedal and the pedal board as well as its bonding properties with respect to another vinyl sheet. If the vinyl sheet is heated up in order to be applied to a surface, the sheet may expand temporarily, but after the sheet begins to cool, it may shrink back to its original dimensions. Therefore, the amount of heat applied to the vinyl sheet should not exceed 150° F. in order for the sheet to remain bonded to the surface onto which it is applied.

In an embodiment, a vinyl sheet may be attached to the pedal board via an adhesive (e.g., dissipative, mechanical, electrostatic, chemical, etc.). For example, the bottom surface of the vinyl sheet may be treated with an adhesive that allows the vinyl sheet to stick to the pedal board. The top surface of the vinyl sheet may not be treated with an adhesive. The bottom surface of the vinyl sheet may be treated with an adhesive so that the vinyl remains attached to the pedal board whenever the effect pedal is attached past conditions where a vinyl sheet that is not treated with an adhesive would fail to remain attached to the pedal board.

In an embodiment, a vinyl sheet may be attached to the effect pedal via an adhesive. For example, the top surface of the vinyl sheet may be treated with an adhesive that allows the vinyl sheet to stick to the effect pedal. The bottom surface of the vinyl sheet may not be treated with an adhesive. The top surface of the vinyl sheet may be treated with an adhesive (e.g., dissipative, mechanical, electrostatic, chemical, etc.) so that the vinyl remains attached to the effect pedal whenever the effect pedal is attached past conditions where a vinyl sheet that is not treated with an adhesive would fail to remain attached to the pedal board. In another embodiment, the top adhesive-treated surface of the vinyl may attach to a padding material that is placed in between the vinyl sheet and the effect pedal.

In some embodiments, the pedal board may be flat and lay parallel to the ground. In another embodiment, the pedal board may be inclined or angled while the effect pedals are attached to the pedal board. In some cases, the pedal board may be angled up to 85° as measured from the ground. The effect pedals that are attached to the pedal board via vinyl sheets may remain attached to the pedal board up to 85°. The effect pedals may stay attached to the pedal board angled up to 85° if they measure 3 lbs or less. If the combination of effect pedal weight being less than 3 lbs or the angle of the pedal board being less than 85°, the vinyl sheet may be able to maintain adhesion and the effect pedals may remain attached to the pedal board.

In some embodiments, the orientation of the effect pedal on the pedal board may not affect the strength of interaction between the effect pedal's vinyl sheet and the pedal board's vinyl sheet. For example, an effect pedal may be placed on the pedal board such that the longest side of the effect pedal is oriented to be parallel with the shorter side of the pedal board. If the effect pedal is removed from the pedal board and rotated by any number of degrees and then replaced onto the pedal board, the effect pedal will still be able to stick onto the pedal board. That is to say, the strength of interaction between the effect pedal and the pedal board is isotropic —any orientation of the effect pedal placed on the pedal board yields about the same strength of interaction between the two vinyl sheets. This feature is a consequence of the vinyl's biaxially oriented property; the tensile strength in both the machine direction and the transverse direction are about the same.

In some embodiments, an effect pedal board needs to be removed and relocated to a different location on the pedal board. The need to rearrange the effect pedals may be due to change the audio signal chain, to adjust the positioning of the effect pedal, or any other reason that would be apparent to one of skill in the art in possession of the present disclosure. The vinyl sheet attached to the bottom of the effect pedal (or the padding material) can easily detach from the vinyl sheet attached to the top of the pedal board. The need to rearrange the effect pedals may cause for the number of rearrangements to be quite numerous. The adhesion of the vinyl sheets to one another is robust; they can be detached from one another and reattached many times without needing to be replaced or losing any strength in the interaction that bonds or coheres them together.

In some embodiments, the force required to remove the effect pedal from the pedal board may be minimal. That is, the force required to remove the effect pedal may be comparable to the force required to lift an effect pedal in opposition to the force of gravity. If the effect pedal weighs 3 lbs, then the force required to remove the effect pedal from the pedal board, in the normal direction of the pedal board surface, may be about 3 lbs.

In some embodiments, the vinyl sheets are attached to the effect pedal and the pedal board permanently. Once the vinyl sheets are set onto the surfaces of the effect pedal and the pedal board, they are not removed. The effect pedal may be able to be picked off of the pedal board, but the vinyl sheets remain attached to the effect pedal and the pedal board. In another embodiment, the vinyl sheets may be removable from the pedal board or the effect pedals. For example, a vinyl sheet may be placed on the bottom of a first effect pedal (either on its bottom surface or on a padding material placed between the effect pedal and the vinyl sheet) but may be removed in order to be placed on a second effect pedal. The vinyl sheet can be removed from the bottom of the first effect pedal with minimal force and attached to the bottom of second effect pedal. The second effect pedal may then be placed onto the vinyl coated pedal board.

In some embodiments, the vinyl sheets may be easily removed from the effect pedals (or padding material) and the pedal board. If the sheets are easily removable, the sheets can easily be replaced if damaged. The vinyl sheets may also be easily transferred from one effect pedal to a second effect pedal in order to allow the placement of the second effect pedal onto the pedal board. The easy transferability may help reduce the amount of vinyl sheets need to place effect pedals on the pedal board. For example, if a pedal board can hold up to 10 effect pedals, then an 11^{th} effect pedal may be easily placed on the pedal board by detaching a first effect pedal from the pedal board, removing the vinyl sheet from the bottom surface of the first effect pedal, applying the removed vinyl sheet onto the 11^{th} effect pedal, and attaching the 11^{th} effect pedal on the pedal board in the place where the first pedal was originally attached to the pedal board.

In some embodiments, the vinyl sheet on the bottom surface of the effect pedal (or padding material) may bond to the vinyl sheet on the top surface of the pedal board. Bonding may occur whenever the two vinyl sheets have different physical properties. For example, the tensile strength, density, surface energy, etc. may be different such that the measured physical property values are more than a 5% difference between the two vinyl sheets. In another embodiment, the vinyl sheet on the bottom surface of the effect pedal (or padding material) may cohere to the vinyl sheet on the top surface of the pedal board. Coherence may occur whenever the vinyl sheets have physical properties that are the same or about the same. For example, the tensile strength, density, surface energy, etc. may be measured to less than a 5% difference between the two vinyl sheets. If the vinyl sheets measure (e.g., using ASTM measuring standards) to have physical properties that are less than 5% different from one another, the vinyl sheets will cohere to one another when they are brought together. If the vinyl sheets cohere, they will interact and bind together in the same manner as described above for the bonding of the vinyl sheets.

In some embodiments, a third vinyl sheet may be placed in between the vinyl sheet attached to the bottom surface of the effect pedal (or padding material) and the top surface of the pedal board. The third vinyl sheet may have about the same physical properties as the first or second vinyl sheet, or the third vinyl sheet may have different physical properties (while still falling within the ranges described above).

In some embodiments, only one sheet of vinyl is required to keep an effect pedal attached to a pedal board. For example, the two surfaces of a flat vinyl sheet may have different physical properties from one another. The surface energy of the bottom side of the vinyl sheet may be much greater than the surface energy of the top side of the vinyl sheet. This type of vinyl sheet may be placed permanently on the top surface of the pedal board. An effect pedal may then be placed on the vinyl sheet, where its bottom surface makes contact with the top side of the vinyl sheet. The effect pedal bond to the vinyl sheet and remains stationary on the pedal board. If the effect pedal needs to be removed, it can be detached from the vinyl sheet covering the pedal board. Since the bottom side of the vinyl sheet has a much greater surface energy, it remains attached to the pedal board whenever the effect pedal is removed. This may reduce the amount of vinyl sheet necessary for the effect pedals to bond to the pedal board.

In some embodiments, the pedal board and the effect pedal may have an electromagnetic component for wirelessly coupling signal connections and power to the effect pedals on a pedal board. These electromagnetic components may be used to wirelessly power and couple signal connections to the effect pedals at the pedal board. If the electromagnetic components are attached at the bottom surface of the effect pedal and the top surface of the pedal board, the vinyl sheet may be attached onto the surface of the electromagnetic components of the effect pedals or the pedal board, or a padding material may be used between the vinyl sheet and the electromagnetic components of the effect pedal.

In some embodiments, an effect pedal may be attached to the pedal board without the use of vinyl sheets. For example, a first magnet may be placed on the bottom of the effect pedal and a second magnet may be placed on the pedal board. The magnet on the pedal board may be located on the top side of the pedal board—the surface where the effect pedal is placed upon—on the bottom side of the pedal board, or the magnet may be placed inside the pedal board. In some embodiments, the pedal board may be made of a magnetic material so that no external magnet needs to be attached to the pedal board. When the effect pedal is placed onto the pedal board, the effect pedal remains fixed to the pedal board. The effect pedal may remain attached to the pedal board when the pedal board is placed at an angle with respect to a resting surface. For example, the effect pedal may stay on the pedal board up until the pedal board makes an 85° angle with the surface the pedal board is resting upon. The force required to remove the effect pedal may be minimal—the force require to remove the effect pedal in the direction normal to the surface of the pedal board should be comparable to the force required to lift an effect pedal in opposition to the force of gravity. If the effect pedal weighs 3 lbs, then the force required to remove the effect pedal from the pedal board should be about 3 lbs.

In some embodiments, the orientation of the effect pedal when placed on the pedal board does not affect the strength of interaction between the magnet attached to the effect pedal and the magnet of the pedal board. If the effect pedal is removed from the pedal board, rotated, and then replaced on the pedal board, the strength of interaction between the magnets remains about the same.

In some embodiments, the effects pedals may be attached to the effect pedal board by use of a synthetic bonding such as nano tape. Nano tape may comprise array of carbon nanotubes that are present on a backing material or flexible polymer tape. Nano tape is attached to an effect pedal and bonds to the effect pedal by taking advantage of van der Waals forces between the effect pedal (or padding material attached to the effect pedal) and the nano tape. The nano tape may have different surface properties for the two surfaces that come into contact with the bottom surface of the effect pedal and the top surface of the pedal board. For example, a nano tape may have carbon nano tubes present on the first side of the tape which bonds (or coheres) to the effect pedal or padding material. The second side of the nano tape may be a different material, e.g., a vinyl layer, that bonds to the effect pedal board. In one embodiment, there is only one sheet of nano tape present between the effect pedal and the pedal board. The nano tape may permanently be attached to the effect pedal if the surfaces are as described above. The nano tape may permanently be attached to the effect pedal board if the second side of the nano tape, which bonds to the effect pedal boards, has the carbon nano tubes present, and the first side of the nano tape attached to the effect pedal or padding material is of a different material than the second side, e.g., a vinyl layer.

In some embodiments, to remove an effect pedal whose bottom surface is covered in nano tape from the pedal board, the force required for removal may be significantly greater than the force of gravity to remove an effect pedal that is not attached to the pedal board via an adhesive. Since the bonding between the nano tape and the bottom surface of the effect pedal (or padding material) is stronger than the bonding between a vinyl sheet and the bottom surface, the amount of nano tape required to bond the effect pedal to the pedal board is much less. For example, a bottom surface of an effect pedal board may only need 20% of its surface covered in nano tape. The adhesion coefficient of the nano tape may be between 0.04 and 0.07. In some embodiments, it may be beneficial to attach numerous small pieces of nano tape to the effect pedal instead of a larger singular piece. For example, in some embodiments, adhesion and removal of the effect pedal from the pedal board is performed better whenever four small pieces of nano tape are attached to the four corners of the effect pedal. This contrasts with having a single sheet of nano tape attached to the effect pedal. Due to the means for which the nano tape bonds to the bottom surface of the effect pedal, the nano tape may be removed and replaced a large number of times without the adhesion strength diminishing. This is due to the fact that nano tapes do not leave any type of adhesive residue on the surfaces to which they are placed. The van der Waals force that binds the nano tape to a surface is determine from the nano tube structure that is present on the nano tape and not the chemical structure of the tape surfaces (e.g., removing the tape from the effect pedal's bottom surface does not remove any type of chemical layer that plays the important layer in the adhesive bonding).

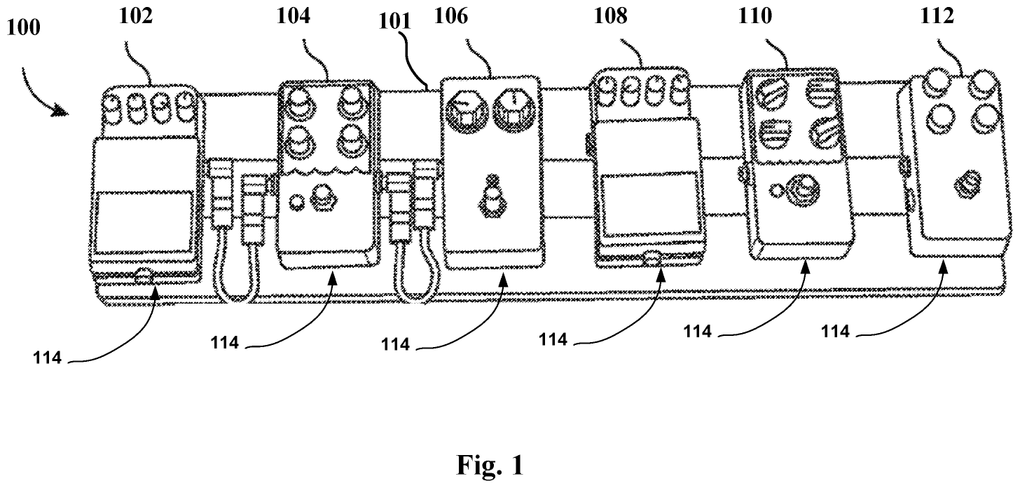

FIG. 1 illustrates a perspective view of a pedal board bonding system 100, in accordance with an embodiment of the present disclosure. The pedal board bonding system 100 may include a pedal board 101 and a plurality of effect pedals 102-112. The pedal board 101 may hold one or more effect pedals of the effect pedals 102-112. The ordering of the effect pedals 102 may affect the output signal; when the effect pedals are rearranged, the output signal changes based on the position that an effect pedal is located on the pedal board 101 or based on the other types of effect pedals that are positioned on the pedal board 101. For example, effect pedal 102 is switched with effect pedal 108, the output signal will be different from the output signal produced by the configuration shown in FIG. 1. Each of the effect pedals 102-112 are attached to the pedal board 101 via one or more pedal board attachment layer 114. For example, the pedal board attachment layer 114 may include vinyl sheet, a nano tape, or a magnet system, as discussed above. In some embodiments, all the effect pedals 102-112 may be coupled to a single pedal board attachment layer 114 or various combinations of pedal board attachment layers 114. For example, the pedal board attachment layer 114 may include a vinyl sheet that is attached to a bottom surface of each effect pedal 102-112. When a separate pedal board attachment layer is attached to an effect pedal 102-112, that pedal board attachment layer may be referred to herein as a pedal attachment layer. In some embodiments, the pedal board attachment layer 114, which may include a vinyl sheet, may also be attached to the top surface of the pedal board 101. For example, the top surface of the pedal board 101 may have one or more vinyl sheets attached to it. As such, there may be multiple pedal board attachment layers 114 sandwiched between an effect pedal (e.g., effect pedal 102) such that the stack includes a pedal board 101, a pedal board attachment layer with a bottom surface of the pedal board attachment layer being directly adjacent to a top surface of the pedal board, a pedal attachment layer with a bottom surface of the pedal attachment layer being directly adjacent to a top surface of the pedal board attachment layer, and an effect pedal where the bottom surface of the effect pedal is directly adjacent a top surface of the pedal attachment layer.

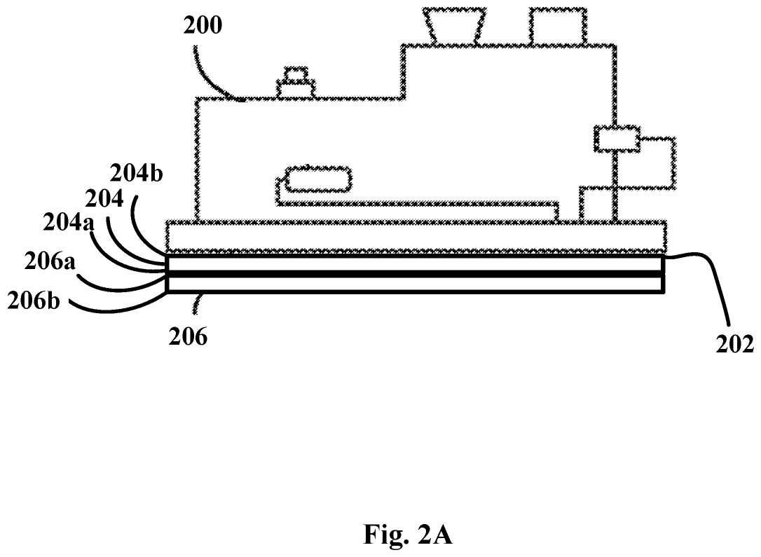

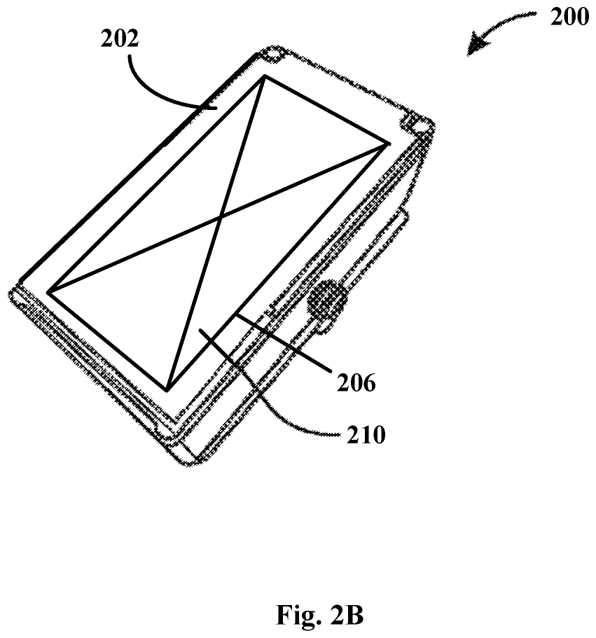

FIG. 2A illustrates a side view of an effect pedal 200, which may be any of the effect pedals 102-112 of FIG. 1, in accordance with various embodiments of the present disclosure. The effect pedal 200 may include a bottom surface 202. In an embodiment, the bottom surface 202 may be smooth or flat If the bottom surface 202 is smooth and flat, then a pedal attachment layer 206 will cling (e.g., bond, adhere, cohere, stick, couple, or connect) to the bottom surface 202. Smoothness of the bottom surface 202 may be measured as the surface roughness of the material comprising the bottom surface 202 of the effect pedal 200. For example, if the surface roughness has an absolute roughness coefficient between 0.5-10.0 micrometers, then the bottom surface 202 may be smooth enough for the pedal attachment layer 206 to cling to the bottom surface 202. For the bottom surface 202 to be flat, the flatness control tolerance may be less than 0.2 mm. The smoothness of the bottom surface 202 should be to such a degree that a pedal board coupling member couples to the bottom surface 202 to provide a van Der Waals force. The force required to remove the van Der Waals force may be less than twice the weight of the effect pedal 200 but, in some embodiments, greater than the weight. If the bottom surface 202 is not smooth or flat, such as the case whenever there may be screws or pins protruding from the bottom surface 202, a padding material 204 may be connected onto the bottom surface 202 that includes a surface smoothness or flatness on its bottom surface to cause the pedal board attachment layer to “cling” to a bottom surface 204a of the padding material. A top surface 204b may be directly adjacent the bottom surface 202 by an adhesive (e.g., dissipative, mechanical, electrostatic, chemical, etc.), or the padding material 204 may be mechanically locked onto the bottom surface 202. A top surface 206a of the pedal attachment layer 206 may then be attached to the bottom surface 204a of the padding material 204 or the bottom surface 202 of the effect pedal 200.

FIG. 2B is a bottom, perspective view of the effect pedal 200, according to various embodiments of the present disclosure. An alternative embodiment of the pedal attachment layer 206, which includes a vinyl sheet 210. The vinyl sheet 210 may be attached to the bottom surface 202202 of the effect pedal 200. The area of the vinyl sheet 210 attached to the bottom surface 202 of the effect pedal 200 may be the same area of the bottom surface 202 of the effect pedal 200 or the vinyl sheet 210 may be as little as 50% of the area of the bottom surface 202 of the effect pedal 200. In some embodiments, the vinyl sheet 210 may attach to the bottom surface 202 without an adhesive (e.g., via cohesive attraction). The vinyl sheet 210 may be easily removed and replaced to the bottom surface 202 of the effect pedal 200. Easily removing the vinyl sheet 210 may be done by simply peeling off the vinyl sheet 210 from the bottom surface 202 (there is no need to treat the vinyl sheet 210 with any chemical or thermal treatment), and the vinyl sheet 210 may be easily replaced to the bottom surface 202 by placing the vinyl sheet 210 in contact with the bottom surface 202—a van Der Waals force may be created once again when the vinyl sheet 210 comes into contact with the bottom surface 202. In another embodiment, the vinyl sheet 210 may attach to the bottom surface 202 by use of an adhesive (e.g., dissipative, mechanical, electrostatic, chemical, etc.). Depending on the adhesive, the vinyl sheet 210 may be permanently attached to the bottom surface 202, or it may be removed and replaced. The bottom surface 202 may be covered in multiple vinyl sheets, in which case the vinyl sheet 210 may be overlapped or layered with multiple vinyl sheets. In another embodiment, the bottom surface 202 includes the padding material 204 covered in one or more vinyl sheets as described above.

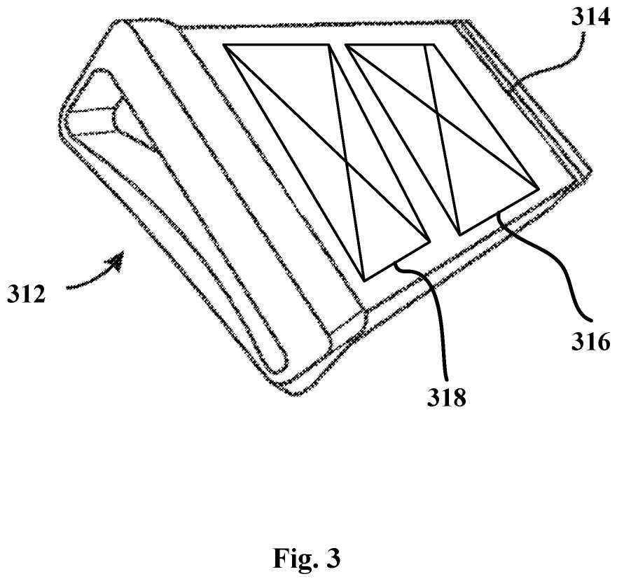

FIG. 3 is a perspective view of a pedal board 312 that may include the pedal board 101 of FIG. 1. Pedal board attachment layers 316-318 (e.g., vinyl sheets, magnets, or nano tape) may be attached to a top surface 314 of the pedal board 312. The area of the pedal board attachment layers 316-318 attached to the pedal board attachment layer 314 of the pedal board 312 may be the same as the area of the top surface 314 of the pedal board 312, or the pedal board attachment layers 316-318 may be as little as 50% of the area of the pedal board attachment layer 314 of the pedal board 312. In one embodiment, the pedal board attachment layers 316-318 may attach to the top surface 304 without an adhesive (e.g., via cohesive attraction). The pedal board attachment layers 310 may be easily removed and replaced to the top surface 314 of the pedal board 312. In another embodiment, the pedal board attachment layers 316-318 may attach to the top surface 314 by use of an adhesive (e.g., dissipative, mechanical, electrostatic, chemical, etc.). Depending on the adhesive, the pedal board attachment layers 316-318 may be permanently attached to the top surface 314, or they may be removed and replaced. In another embodiment, pedal board attachment layer 316 may be layered with multiple vinyl sheets or other pedal board attachment layers and pedal board attachment layer 316 maybe layered with multiple vinyl sheets or other pedal board attachment layers. The top surface 314 may be covered in a single pedal board attachment layer 316, in which case the pedal board attachment layer 318 is not present. The single pedal board attachment layer 316 may be the same area of the top surface 314 of the pedal board 312 or the single vinyl sheet 316 may be as little as 50% of the area of the top surface of the pedal board 312.

FIG. 44 is a flowchart illustrating a method 4400 of assembling a pedal board bonding system. In the first step 402, a first effect pedal (e.g., an effect pedal 102/200) is received by an effect pedal board (e.g., the pedal board 101/312 of FIG. 1 and FIG. 3, respectively) at a first location on the effect pedal board. The first effect pedal's bottom surface may be coupled with a first effect pedal attachment layer and the top surface of the effect pedal board is covered in a pedal board attachment layer. In order for the effect pedal board to receive the first effect pedal, the first effect pedal attachment layer may bond to the pedal board attachment layer. At a second step 404, a second effect pedal (e.g., an effect pedal 104/200) may be received at a second location on the effect pedal board. The second effect pedal's bottom surface may be covered by the second effect pedal attachment layer. For the effect pedal board to receive the second effect pedal, the second pedal attachment layer may bond to the pedal board attachment layer. At step 406, the first effect pedal or the second effect pedal are removed from the pedal board. In some embodiments, at block 406 the amount of force required to remove the first effect pedal or the second effect pedal from their respective locations on the pedal board is 1 to 1.5 times the weight of the effect pedals. The removal of the first effect pedal from the first location or the removal of the second effect pedal from the second location includes breaking the bond between the effect pedal attachment layers and their respective pedal board attachment layers. At step 408, the first effect pedal is received by the pedal board at the second location on the pedal board. At step 410, the second pedal is received by the pedal board at the first location.

In block diagrams, illustrated components are depicted as discrete functional blocks, but embodiments are not limited to systems in which the functionality described herein is organized as illustrated. The functionality provided by each of the components may be provided by software or hardware modules that are differently organized than is presently depicted, for example such software or hardware may be intermingled, conjoined, replicated, broken up, distributed (e.g., within a data center or geographically), or otherwise differently organized. The functionality described herein may be provided by one or more processors of one or more computers executing code stored on a tangible, non-transitory, machine-readable medium. In some cases, third party content delivery networks may host some or all of the information conveyed over networks, in which case, to the extent information (e.g., content) is said to be supplied or otherwise provided, the information may be provided by sending instructions to retrieve that information from a content delivery network.

The reader should appreciate that the present application describes several inventions. Rather than separating those inventions into multiple isolated patent applications, applicant has grouped these inventions into a single document because their related subject matter lends itself to economies in the application process. But the distinct advantages and aspects of such inventions should not be conflated. In some cases, embodiments address all of the deficiencies noted herein, but it should be understood that the inventions are independently useful, and some embodiments address only a subset of such problems or offer other, unmentioned benefits that will be apparent to those of skill in the art reviewing the present disclosure. Due to cost constraints, some inventions disclosed herein may not be presently claimed and may be claimed in later filings, such as continuation applications or by amending the present claims. Similarly, due to space constraints, neither the Abstract nor the Summary of the Invention sections of the present document should be taken as containing a comprehensive listing of all such inventions or all aspects of such inventions.

It should be understood that the description and the drawings are not intended to limit the invention to the particular form disclosed, but to the contrary, the intention is to cover all modifications, equivalents, and alternatives falling within the spirit and scope of the present invention as defined by the appended claims. Further modifications and alternative embodiments of various aspects of the invention will be apparent to those skilled in the art in view of this description. Accordingly, this description and the drawings are to be construed as illustrative only and are for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed or omitted, and certain features of the invention may be utilized independently, all as would be apparent to one skilled in the art after having the benefit of this description of the invention. Changes may be made in the elements described herein without departing from the spirit and scope of the invention as described in the following claims. Headings used herein are for organizational purposes only and are not meant to be used to limit the scope of the description.

As used throughout this application, the word “May” is used in a permissive sense (i.e., meaning having the potential to), rather than the mandatory sense (i.e., meaning must). The words “include”, “including”, and “includes” and the like mean including, but not limited to. As used throughout this application, the singular forms “a,” “an,” and “the” include plural referents unless the content explicitly indicates otherwise. Thus, for example, reference to “an element” or “a element” includes a combination of two or more elements, notwithstanding use of other terms and phrases for one or more elements, such as “one or more.” The term “or” is, unless indicated otherwise, non-exclusive, i.e., encompassing both “and” and “or.” Terms describing conditional relationships, e.g., “in response to X, Y,” “upon X, Y,”, “if X, Y,” “when X, Y,” and the like, encompass causal relationships in which the antecedent is a necessary causal condition, the antecedent is a sufficient causal condition, or the antecedent is a contributory causal condition of the consequent, e.g., “state X occurs upon condition Y obtaining” is generic to “X occurs solely upon Y” and “X occurs upon Y and Z.” Such conditional relationships are not limited to consequences that instantly follow the antecedent obtaining, as some consequences may be delayed, and in conditional statements, antecedents are connected to their consequents, e.g., the antecedent is relevant to the likelihood of the consequent occurring. Statements in which a plurality of attributes or functions are mapped to a plurality of objects (e.g., one or more processors performing steps A, B, C, and D) encompasses both all such attributes or functions being mapped to all such objects and subsets of the attributes or functions being mapped to subsets of the attributes or functions (e.g., both all processors each performing steps A-D, and a case in which processor 1 performs step A, processor 2 performs step B and part of step C, and processor 3 performs part of step C and step D), unless otherwise indicated. Further, unless otherwise indicated, statements that one value or action is “based on” another condition or value encompass both instances in which the condition or value is the sole factor and instances in which the condition or value is one factor among a plurality of factors. Unless otherwise indicated, statements that “each” instance of some collection have some property should not be read to exclude cases where some otherwise identical or similar members of a larger collection do not have the property, i.e., each does not necessarily mean each and every. Unless specifically stated otherwise, as apparent from the discussion, it is appreciated that throughout this specification discussions utilizing terms such as “processing,” “computing,” “calculating,” “determining” or the like refer to actions or processes of a specific apparatus, such as a special purpose computer or a similar special purpose electronic processing/computing device.

The present techniques will be better understood in view of the following enumerated embodiments:

1. An pedal board bonding system, comprising: a first effect pedal; a pedal board configured to mount the first effect pedal; a first pedal attachment layer attached to first effect pedal; and a pedal board attachment layer attached to the pedal board, where the pedal board attachment layer is configured to bond to the first pedal attachment layer.
2. The pedal board bonding system of embodiment 1, wherein: the pedal board attachment layer and the first pedal attachment layer are configured to detach from each other when a force is applied to the pedal board before the pedal board attachment layer detaches from the pedal board or the first pedal attachment layer detaches from the first effect pedal.
3. The pedal board bonding system of embodiment 2, wherein the first effect pedal reattaches to the pedal board at a different location or the same location.
4. The pedal board bonding system of any one of embodiments 1-3, wherein the pedal board is smooth and non-porous.
5. The pedal board bonding system of any one of embodiments 1-4, wherein the pedal board has a surface energy greater than or equal to 30 dynes/cm.
6. The pedal board bonding system of any one of embodiments 1-5, wherein: the first pedal attachment layer includes a first polyvinyl chloride sheet or a first chlorinated polyvinyl chloride sheet; and the pedal board attachment layer comprises a second polyvinyl chloride sheet or a second chlorinated polyvinyl chloride sheet.
7. The pedal board bonding system of any one of embodiments 1-6, wherein: the first polyvinyl chloride sheet remains attached to the first effect pedal in a temperature range of −10° F. to 150° F.; and the second polyvinyl chloride sheet remains attached to the pedal board in a temperature range of −10° F. to 150° F.
8. The pedal board bonding system any one of embodiments 6-7, wherein: the first pedal attachment layer covers at least 50% of a bottom surface of the first effect pedal; and the second polyvinyl chloride sheet covers at least 50% of a top surface of the pedal board.
9. The pedal board bonding system of any one of embodiments 1-8, wherein: a pedal attachment layer thickness of the first pedal attachment layer ranges from 4 mm to 8 mm; and a pedal board attachment layer thickness of the pedal board attachment layer ranges from 4 mm to 8 mm.
10. The pedal board bonding system of any one of embodiments 1-9, wherein a first padding material is bonded in between the first effect pedal and the first pedal attachment layer.
11. The pedal board bonding system of any one of embodiments 1-10, wherein: the first pedal attachment layer has a surface energy in a range of 30 dynes/cm to 40 dynes/cm; and the pedal board attachment layer has a surface energy in a range of 30 dynes/cm to 40 dynes/cm.
12. The pedal board bonding system of any one of embodiments 1-11, wherein the first effect pedal weighs less than or equal to 3 lbs.
13. The pedal board bonding system of any one of embodiments 1-12, wherein the pedal board is inclined less or equal to 85° from a ground surface.
14. The pedal board bonding system of any one of embodiments 1-13, wherein: the first effect pedal bonds to the pedal board when the first pedal attachment layer bonds to the pedal board attachment layer; and the first effect pedal bonds to the pedal board with a first bonding strength.
15. The pedal board bonding system of embodiment 14, wherein a force to remove the first effect pedal from the pedal board is the less than or equal to 1.5 times a force opposite a gravitational force that is required to lift the first effect pedal.
16. The pedal board bonding system of embodiment 14, wherein a second bonding strength between the first effect pedal that was removed and that is reattached to the pedal board is the same as the first bonding strength between the first effect pedal and the pedal board.
17. The pedal board bonding system of any one of embodiments 1-16, further comprising: a second effect pedal; and a second pedal attachment layer attached to the second effect pedal, wherein the pedal board attachment layer is configured to bond to the second pedal attachment layer.
18. A method of operating an pedal board bonding system comprising: receiving, at a pedal board, a first effect pedal at a first location on the pedal board; bonding the first effect pedal to the first location on the pedal board by placing a first effect pedal attachment layer between a first bottom surface of the first effect pedal and a top surface of the pedal board at the first location; removing, from the pedal board, the first effect pedal; receiving, at the pedal board, the first effect pedal at a second location on the pedal board; and bonding the first effect pedal to the second location on the pedal board by placing the first effect pedal attachment layer between the first bottom surface of the first effect pedal and the top surface of the pedal board at the second location.
19. The method of embodiment 18, further comprising: receiving, at the pedal board, a second effect pedal at the second location on the pedal board; bonding the second effect pedal to the second location on the pedal board by placing a second effect pedal attachment layer, located on a second bottom surface of the second effect pedal on top of a pedal board attachment layer, located on the top surface of the pedal board.
20. The method of any one of embodiments 18-19, wherein removing the second effect pedal comprises detaching the second effect pedal attachment layer from the pedal board attachment layer.

What is claimed is:

1. An pedal board bonding system, comprising:
a first effect pedal;
a pedal board configured to mount the first effect pedal;
a first pedal attachment layer attached to first effect pedal; and
a pedal board attachment layer attached to the pedal board, where the pedal board attachment layer is configured to bond to the first pedal attachment layer.

2. The pedal board bonding system of claim 1, wherein:
the pedal board attachment layer and the first pedal attachment layer are configured to detach from each other when a force is applied to the pedal board before the pedal board attachment layer detaches from the pedal board or the first pedal attachment layer detaches from the first effect pedal.

3. The pedal board bonding system of claim 2, wherein the first effect pedal reattaches to the pedal board at a different location or the same location.

4. The pedal board bonding system of claim 1, wherein the pedal board is smooth and non-porous.

5. The pedal board bonding system of claim 1, wherein the pedal board has a surface energy greater than or equal to 30 dynes/cm.

6. The pedal board bonding system of claim 1, wherein:
the first pedal attachment layer includes a first polyvinyl chloride sheet or a first chlorinated polyvinyl chloride sheet; and
the pedal board attachment layer comprises a second polyvinyl chloride sheet or a second chlorinated polyvinyl chloride sheet.

7. The pedal board bonding system of claim 6, wherein:
the first polyvinyl chloride sheet remains attached to the first effect pedal in a temperature range of −10° F. to 150° F.; and
the second polyvinyl chloride sheet remains attached to the pedal board in a temperature range of −10° F. to 150° F.

8. The pedal board bonding system of claim 6, wherein:
the first pedal attachment layer covers at least 50% of a bottom surface of the first effect pedal; and
the second polyvinyl chloride sheet covers at least 50% of a top surface of the pedal board.

9. The pedal board bonding system of claim 1, wherein:
a pedal attachment layer thickness of the first pedal attachment layer ranges from 4 mm to 8 mm; and
a pedal board attachment layer thickness of the pedal board attachment layer ranges from 4 mm to 8 mm.

10. The pedal board bonding system of claim 1, wherein a first padding material is bonded in between the first effect pedal and the first pedal attachment layer.

11. The pedal board bonding system of claim 1, wherein:
the first pedal attachment layer has a surface energy in a range of 30 dynes/cm to 40 dynes/cm; and
the pedal board attachment layer has a surface energy in a range of 30 dynes/cm to 40 dynes/cm.

12. The pedal board bonding system of claim 1, wherein the first effect pedal weighs less than or equal to 3 lbs.

13. The pedal board bonding system of claim 1, wherein the pedal board is inclined less or equal to 85° from a ground surface.

14. The pedal board bonding system of claim 1, wherein:
the first effect pedal bonds to the pedal board when the first pedal attachment layer bonds to the pedal board attachment layer; and
the first effect pedal bonds to the pedal board with a first bonding strength.

15. The pedal board bonding system of claim 14, wherein a force to remove the first effect pedal from the pedal board is greater than 1.0 times and less than or equal to 1.5 times a force opposite a gravitational force that is required to lift the first effect pedal.

16. The pedal board bonding system of claim 14, wherein a second bonding strength between the first effect pedal that was removed and that is reattached to the pedal board is the same as the first bonding strength between the first effect pedal and the pedal board.

17. The pedal board bonding system of claim 1, further comprising:
a second effect pedal; and
a second pedal attachment layer attached to the second effect pedal, wherein the pedal board attachment layer is configured to bond to the second pedal attachment layer.

18. A method of operating a pedal board bonding system comprising:
receiving, at a pedal board, a first effect pedal at a first location on the pedal board;
bonding the first effect pedal to the first location on the pedal board by placing a first effect pedal attachment layer between a first bottom surface of the first effect pedal and a top surface of the pedal board at the first location;
removing, from the pedal board, the first effect pedal;
receiving, at the pedal board, the first effect pedal at a second location on the pedal board; and
bonding the first effect pedal to the second location on the pedal board by placing the first effect pedal attachment layer between the first bottom surface of the first effect pedal and the top surface of the pedal board at the second location.

19. The method of claim 18, further comprising:
receiving, at the pedal board, a second effect pedal at the second location on the pedal board;
bonding the second effect pedal to the second location on the pedal board by placing a second effect pedal attachment layer, located on a second bottom surface of the second effect pedal on top of a pedal board attachment layer, located on the top surface of the pedal board.

20. The method of claim 19, wherein removing the second effect pedal comprises detaching the second effect pedal attachment layer from the pedal board attachment layer.
